(19) United States
(12) Patent Application Publication
(10) Pub. No.: US 2010/0235319 A1
(43) Pub. Date: Sep. 16, 2010

(54) Method and System for Converting Virtual Item

(75) Inventors: Xianming Liu, Shenzhen (CN); Xinghua Zhuang, Shenzhen (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Tencent Tecnology ( Shenzhen) Company Ltd, Shenzhen (CN)

(21) Appl. No.: 12/679,479

(22) PCT Filed: Aug. 21, 2008
(86) PCT No.: PCT/CN2008/072074

§ 371 Date: Mar. 22, 2010

(30) Foreign Application Priority Data
Sep. 29, 2007 (CN) 200710164102.7

(51) Int. Cl. G06F 17/30; G06F 15/16; G06F 3/00; G06F 7/00

(52) U.S. Cl. 707/609; 709/203; 715/733; 707/705; 707/758

(57) ABSTRACT

A method for converting a virtual item includes: obtaining a pre-configured virtual item converting probability from a database; obtaining a value of an original virtual item to be converted; and generating a new virtual item according to the value of the original virtual item and the pre-configured virtual item converting probability obtained from the database. Through the above solution, a new virtual item may be generated according to the value of the original virtual item and the pre-configured virtual item converting probability.

This patent application claims the priority of Chinese patent application No. 200710164102.7, entitled “method and system for converting virtual items”, filed on Sep. 29, 2007. The whole content is incorporated herein by reference.

### FIELD OF THE INVENTION

The present invention relates to computer fields, and more particularly, to a method and system for converting a virtual item.

### BACKGROUND OF THE INVENTION

With development of the Internet, network communities and network games become popular. Virtual items in the network communities become more and more various and numerous. The virtual items refer to weapons, pets, accounts, virtual coins and even user attributes in the network communities or network games. The virtual items are generally defined and provided on virtual networks by operators of the network communities and network games. Users of the network communities and network games obtain the virtual items based on requirements through their corresponding access information such as accounts and/or passwords in the communities or the games. The users may also manage their virtual items, e.g. use, deal, transfer, maintain, change attributes, exchange, etc.

The various virtual items are important means for the network communities and network games to attract users. In addition, in order to possess a virtual item with a more advanced attribute or keep experiences fresh, users always convert their virtual items, i.e. generate a new virtual item based on the original virtual item.

As to an existing virtual item converting system in the network communities and network games, the virtual items are converted according to a converting formula A+B=C or other more complicated converting formulas. The converting formulas have been defined before the network communities and the network games begin to operate. Even if the virtual item converting method may be maintained and updated during the operation, it is generally changeless for a long time. As such, the users tend to lose interest in the virtual item converting system, which is not good for improving users' experiences.

### SUMMARY OF THE INVENTION

Embodiments of the present invention provide a method and system for converting a virtual item, so as to generate a new virtual item according to a value of an original virtual item and a pre-configured virtual item converting probability.

According to one embodiment of the present invention, a method for converting a virtual item is provided. The method includes: obtaining a pre-configured virtual item converting probability from a database; obtaining a value of an original virtual item to be converted; and generating a new virtual item according to the value of the original virtual item and the pre-configured virtual item converting probability obtained from the database.

Preferably, the converting the virtual item is performed according to a converting request from a client; the method further includes: before obtaining the value of the original virtual item, searching the database for virtual items that can be used for the converting of the client and transmitting a list of the virtual items found to the client for selecting the original virtual item.

Preferably, before obtaining the value of the original virtual item, determining, by a server, legality of the original virtual item to be converted; if the original virtual item is legal, proceeding to obtaining the value of the original virtual item; otherwise, returning information indicating that the original virtual item cannot be converted to the client.

Preferably, the obtaining the value of the original virtual item includes:

computing the value of the original virtual item according to an original value and a remaining validation period of the original virtual item.

Preferably, the generating the new virtual item includes:

according to the value of the original virtual item and the pre-configured virtual item converting probability, generating a probability table of virtual items that can be converted from the original virtual item corresponding to the value; generating a random number, and determining the new virtual item according to a position where the random number falls in the probability table.

Preferably, the method further includes:

after generating the new virtual item, returning a converting result indicating the new virtual item to the client and updating the database.

Preferably, the method further includes:

after generating the new virtual item, collecting statistics of data stored in the database, and adjusting the virtual item converting probability according to the data stored in the database.

According to another embodiment of the present invention, a system for converting a virtual item is provided. The system includes: a client and a server; the server includes a data storage unit, a virtual item value generating unit, a virtual item generating unit and an interaction interface unit, the interaction interface unit is adapted to provide an interface for the server and the client, receive a virtual item converting request from the client, and transmit a converting result of the server to the client;

the virtual item value generating unit is adapted to compute a value of an original virtual item according to an original value and a remaining validation period of the original virtual item to be converted, and transmit the value of the original virtual item to the virtual item generating unit;

the data storage unit is adapted to store a virtual item converting probability, virtual item data and attribute data corresponding to the client, provide the virtual item converting item to the virtual item generating unit, and provide a virtual item list of the client to the interaction interface unit; and

the virtual item generating unit is adapted to generate a new virtual item according to the value of the original virtual item provided by the virtual item value generating unit and the virtual item converting probability obtained from the data storage unit, and transmit the generated new virtual item to the interaction interface unit and the data storage unit.

Preferably, the server further includes a virtual item checking unit, adapted to check legality of the original virtual item according to a type and an attribute of the original virtual item from the interaction interface unit, transmit a checking result to the virtual item value generating unit if the original virtual item is legal, and return failure information to the interaction interface unit if the original virtual item is illegal.

Preferably, the server further includes a virtual item converting probability adjusting unit, adapted to adjust the virtual item converting probability according to contents stored in the data storage unit.

Preferably, the interaction interface unit is further adapted to provide a list of virtual items that can be used for the converting of the client, receive a type of the original virtual item to be converted from the client, and transmit the type to the virtual item value generating unit.

In the method for converting the virtual item provided by the embodiments of the present invention, the new virtual item is generated according to the value of the original virtual item and the pre-configured virtual item converting probability. Therefore, users may feel fresh and have fun in the network communities and the network games, which improves the user's experience and makes the network communities and the network games more attractive.

The system for converting the virtual item provided by the embodiments of the present invention adopts a standard browser/server architecture, which is applicable to any client and is easy to be accepted by the users. In addition, the system for converting the virtual item provided by the embodiments of the present invention may also generate the new virtual item in real time and adjust the virtual item converting probability frequently, which brings more joy to the users and further improves the user's experience.

### BRIEF DESCRIPTION OF THE DRAWINGS

FIG. 1 is a block diagram illustrating a system for converting a virtual item according to an embodiment of the present invention.

FIG. 2 is a flowchart illustrating a method for converting a virtual item according to an embodiment of the present invention.

### DETAILED DESCRIPTION OF THE INVENTION

The present invention will be described in detail hereinafter with reference to embodiments and accompanying drawings.

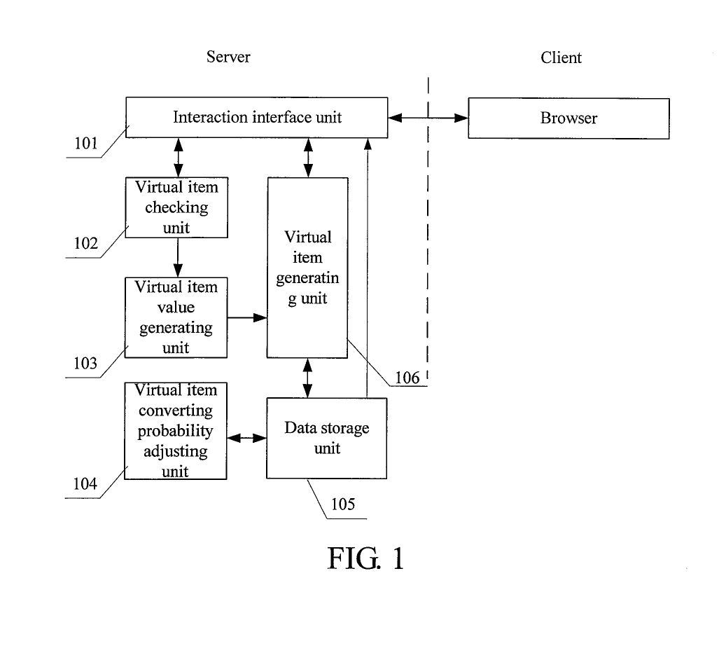

As shown in FIG. 1, a system for converting a virtual item provided by an embodiment of the present invention includes a client and a server. The server includes a data storage unit 105, a virtual item value generating unit 103, a virtual item checking unit 102, a virtual item generating unit 106, a virtual item converting probability adjusting unit 104 and an interaction interface unit 101.

The interaction interface unit 101 is adapted to provide an interface for interaction between the server and the client, receive a virtual item converting request from the client, provide a virtual item list containing virtual items that can be converted by the client to the client, receive a type of an original virtual item to be converted from the client, receive a converting result from the virtual item generating unit 106 and transmit the converting result to the client. To conform to the browser/server architecture, the client visits the interaction interface unit 106 via a browser. The interaction interface unit 106 provides the client with information such as the virtual item list containing the virtual items that can be converted by the client and the converting result in form of a webpage. After obtaining the type of the original virtual item to be converted from the client, the interaction interface unit 106 transmits the type to the virtual item checking unit 102 for checking or directly transmits the type to the virtual item value generating unit 103 for value computation.

The virtual item value generating unit 103 is adapted to compute a current value of the original virtual item according to the original value and a remaining validation period of the original virtual item, provide the virtual item generating unit 106 with the current value. The original value of a virtual item may be defined in advance or computed according to the attribute of the virtual item and how rare the virtual item is. As to the virtual item with a validation period, the remaining validation period should be considered when computing the current value, e.g., the shorter the remaining validation period, the lower the current value.

The data storage unit 105 is adapted to store the virtual item converting probability, virtual item data and attribute data corresponding to the client. These data can be stored as a database. In order to accelerate the access to the data storage unit 105, a Cache for All (C4A) technique may be adopted to store all the data of the data storage unit 105 into a memory unit during operation of the server to increase data access speed of the client. According to a virtual item converting request transmitted by the client, the data storage unit 105 is further adapted to return virtual items that can be converted by the client and transmit a virtual item list containing the virtual items and their attributes to the interaction interface unit 101. The data storage unit 105 is further adapted to provide the virtual item generating unit 106 with the virtual item converting probability.

The virtual item generating unit 106 is adapted to generate a new virtual item according to the current value of the original virtual item provided by the virtual item value generating unit 103 and the virtual item converting probability obtained from the data storage unit 106, and transmit the new virtual item to the interaction interface unit 101 and the data storage unit 105. The generating the new virtual item includes: generating a virtual item probability table containing virtual items that could be generated corresponding to the current value of the original virtual item and the pre-configured virtual item converting probability; then generating a random number, and determining the new virtual item according to a position where the random number falls in the virtual item probability table.

The virtual item checking unit 102 is adapted to determine legality of the original virtual item according to the type and attribute of the original virtual item transmitted from the interaction interface unit 101, transmit a checking result to the virtual item value generating unit 103 if the original virtual item is legal, and return fault information to the interaction interface unit 101 if the original virtual item is illegal. The determining the legality may include: determining whether the original virtual item can be used for virtual item conversion or whether the virtual item is within its validation period, etc.

The virtual item converting probability adjusting unit 104 is adapted to adjust the virtual item converting probability according to contents of the data storage unit 101. For example, the adjusting may include: if the number of a certain type of virtual items is small during a period, adjusting the virtual item converting probability upwards.

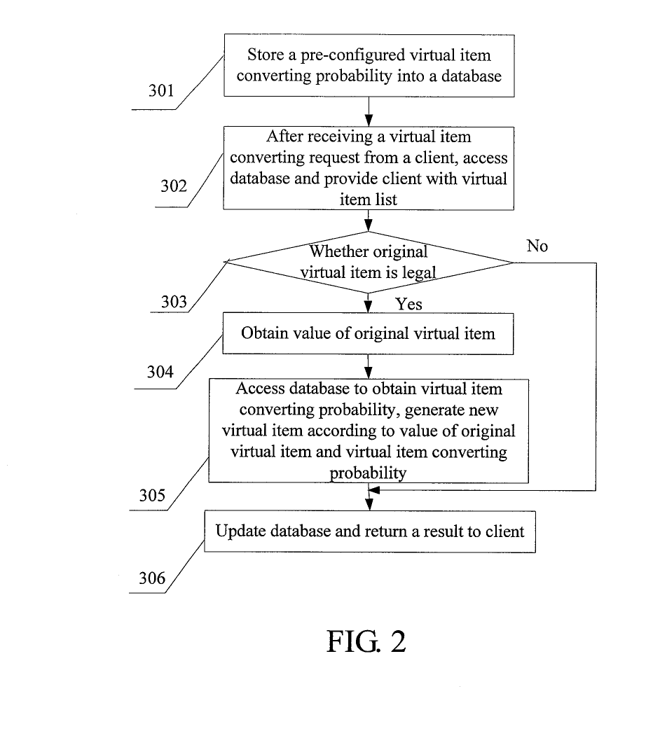

Based on the system for converting the virtual item provided by the embodiment of the present invention, a method for converting the virtual item is provided according to another embodiment of the present invention. As shown in FIG. 2, the method includes the following steps.

Step 301: Store a pre-configured virtual item converting probability into a database.

The pre-configured virtual item converting probability may be configured manually or be generated automatically according to the attribute of the virtual item. For example, the higher the value of a virtual item, the higher the possibility to generate a virtual item with an advanced attribute.

Step 302: After receiving a virtual item converting request from the client, access the database and provide a virtual item list to the client.

The server accesses the database and searches for the virtual items that can be converted by the client, transmits a list containing the virtual items and their attributes to the client for selecting an original virtual item to be converted. If the server performs automatic conversion on conditions, e.g. performs conversion on a virtual item whose validation period is shorter than a threshold without the user's converting request, Step 302 may be omitted.

Step 303: Determine legality of the original virtual item to be converted.

The determining the legality may include determining whether the virtual item can be used for virtual item conversion or whether the virtual item is within its validation period, etc. If it is determined that the virtual item cannot be used for virtual item conversion, return information indicating that the virtual item cannot be used for virtual item conversion to the client.

Step 304: Obtain the current value of the original virtual item according to the original value of the original virtual item to be converted and the remaining validation period of the original virtual item.

The original value of the virtual item may be configured in advance or computed according to the attribute of the virtual item and how rare the virtual item is. As to the virtual item with a validation period, the remaining validation period should be considered when computing the current value, e.g. the shorter the remaining validation period, the lower the current value.

Step 305: Access the database, obtain a virtual item converting probability and generate a new virtual item according to the current value of the virtual item and the virtual item converting probability.

The generating the new virtual item includes: generating a probability table of virtual items that could be converted from the original virtual item corresponding to the current value according to the original value of the original virtual item and the converting probability; then generating a random number, generating the new virtual item according to a position where the random number falls in the probability table. For example, suppose the current value of the original virtual item is 100, search the database to generate the probability table of the virtual items that can be converted from the original virtual item, the virtual items corresponding to the current value 100. For example, the current value 100 has a probability of a % to be converted into virtual item A, a probability of b % to be converted into virtual item B, and a probability of c % to be converted into virtual item C. Then generate a random number. According to the position where the random number falls in the probability table, determine whether the a converting result is virtual item A, B or C.

Step 306: Update the database and return a result to the client.

The server returns the converting result to the client. If the conversion succeeds, the server returns name, attribute of the new virtual item to the client, updates a field denoting the virtual items owned by the client in the database, deletes the original virtual item and fills with the new virtual item.

In order to make the method for converting the virtual item according to the embodiment of the present invention more flexible, after the above step 306, the method may further include: adjusting the virtual item converting probability according to contents of the database. The adjustment may include: if the number of a certain type of virtual items is small during a period of time, adjusting the converting probability of the virtual item upwards.

The foregoing descriptions are only preferred embodiments of this invention and are not for use in limiting the protection scope thereof. Any changes and modifications can be made by those skilled in the art without departing from this invention and therefore should be covered within the protection scope as set by the appended claims.

1-11. (canceled)

12. A method for converting a virtual item, comprising:
obtaining a pre-configured virtual item converting probability from a database;
obtaining a value of an original virtual item to be converted; and
generating a new virtual item according to the value of the original virtual item and the pre-configured virtual item converting probability obtained from the database.

13. The method of claim 12, wherein the converting the virtual item is performed according to a converting request from a client;
the method further comprises: before obtaining the value of the original virtual item, searching the database for virtual items that can be used for the converting of the client and transmitting a list of the virtual items found to the client for selecting the original virtual item.

14. The method of claim 12, further comprising:
before obtaining the value of the original virtual item, determining, by a server, legality of the original virtual item to be converted;
if the original virtual item is legal, proceeding to obtaining the value of the original virtual item;
otherwise, returning information indicating that the original virtual item cannot be converted to the client.

15. The method of claim 12, wherein the obtaining the value of the original virtual item comprises:
computing the value of the original virtual item according to an original value and a remaining validation period of the original virtual item.

16. The method of claim 12, wherein the generating the new virtual item comprises:
according to the value of the original virtual item and the pre-configured virtual item converting probability, generating a probability table of virtual items that can be converted from the original virtual item corresponding to the value; generating a random number, and determining the new virtual item according to a position where the random number falls in the probability table.

17. The method of claim 12, further comprising:
after generating the new virtual item, returning a converting result indicating the new virtual item to the client and updating the database.

18. The method of claim 12, further comprising:
after generating the new virtual item, collecting statistics of data stored in the database, and adjusting the virtual item converting probability according to the data stored in the database.

19. A system for converting a virtual item, comprising: a client and a server; wherein the server is adapted to: obtain a pre-configured virtual item converting probability, obtain a value of an original virtual item to be converted, generate a new virtual item according to the value of the original virtual item and the pre-configured virtual item converting probability obtained, and transmit a converting result indicating the new virtual item to the client.

20. The system of claim 19, wherein the server comprises a data storage unit, a virtual item value generating unit, a virtual item generating unit and an interaction interface unit;
the interaction interface unit is adapted to provide an interface for the server and the client, receive a virtual item converting request from the client, and transmit the converting result of the server to the client;
the virtual item value generating unit is adapted to compute the value of the original virtual item according to an original value and a remaining validation period of the original virtual item to be converted, and transmit the value of the original virtual item to the virtual item generating unit;
the data storage unit is adapted to store a virtual item converting probability, virtual item data and attribute data corresponding to the client, provide the virtual item converting item to the virtual item generating unit, and provide a virtual item list of the client to the interaction interface unit; and
the virtual item generating unit is adapted to generate the new virtual item according to the value of the original virtual item provided by the virtual item value generating unit and the virtual item converting probability obtained from the data storage unit, and transmit the generated new virtual item to the interaction interface unit and the data storage unit.

21. The system of claim 20, wherein the server further comprises a virtual item checking unit, adapted to check legality of the original virtual item according to a type and an attribute of the original virtual item from the interaction interface unit, transmit a checking result to the virtual item value generating unit if the original virtual item is legal, and return failure information to the interaction interface unit if the original virtual item is illegal.

22. The system of claim 20, wherein the server further comprises a virtual item converting probability adjusting unit, adapted to adjust the virtual item converting probability according to contents stored in the data storage unit.

23. The system of claim 20, wherein the interaction interface unit is further adapted to provide a list of virtual items that can be used for the converting of the client, receive a type of the original virtual item to be converted from the client, and transmit the type to the virtual item value generating unit.

24. The system of claim 21, wherein the interaction interface unit is further adapted to provide a list of virtual items that can be used for the converting of the client, receive a type of the original virtual item to be converted from the client, and transmit the type to the virtual item value generating unit.

25. The system of claim 22, wherein the interaction interface unit is further adapted to provide a list of virtual items that can be used for the converting of the client, receive a type of the original virtual item to be converted from the client, and transmit the type to the virtual item value generating unit.
